(19) United States
(12) Patent Application Publication
(10) Pub. No.: US 2016/0275907 A1
(43) Pub. Date: Sep. 22, 2016

(54) SECURITY SCHEMES FOR ELECTRONIC PAPER DISPLAY DEVICES

(71) Applicant: Microsoft Technology Licensing, LLC, Redmond, WA (US)

(72) Inventors: James Scott, Cambridge (GB); John Franciscus Marie Helmes, Steyl (NL); Stephen Edward Hodges, Cambridge (GB); Nicholas Yen-Cherng Chen, Cambridge (GB); Stuart Taylor, Cambridge (GB)

(21) Appl. No.: 14/664,704

(22) Filed: Mar. 20, 2015

(51) Int. Cl. G09G 5/00; G06F 21/71; G06F 21/44

(52) U.S. Cl. CPC G09G 5/006; G06F 21/44; G06F 21/71; G09G 2380/14; G09G 2370/04; G09G 2370/16; G09G 2358/00

(57) ABSTRACT

A display device comprises an electronic paper display, a security module, an input for receiving content for display on the electronic paper display and a processing element. The security module is arranged to store and/or generate a value that is periodically updated and to communicate the value to a proximate device. A proposed update to the displayed content is accompanied by a further value which is verified by the security module or by a remote content service before updating the content displayed on the electronic paper display.

### BACKGROUND

Electronic paper (or e-paper) describes display technologies which reflect light (like paper) instead of emitting light like conventional back-lit LCD or LED displays. Electronic paper is commonly used for e-reader devices because many electronic paper technologies only require power to change the image displayed and do not require continuous power to maintain the display in between. The electronic paper can therefore hold static images or text for long periods of time (e.g. from several minutes to several hours and even several days, months or years in some examples) without requiring significant power (e.g. without any power supply or with only minimal power consumption). There are a number of different technologies which are used to provide the display, including electrophoretic displays and electro-wetting displays. Many of these displays are also referred to as ‘bi-stable’ displays because they use a mechanism in which a pixel can move between stable states (e.g. a black state and a white state) when powered but holds its state when power is removed.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A display device comprises an electronic paper display, a security module, an input for receiving content for display on the electronic paper display and a processing element. The security module is arranged to store and/or generate a value that is periodically updated and to communicate the value to a proximate device. A proposed update to the displayed content is accompanied by a further value which is verified by the security module or by a remote content service before updating the content displayed on the electronic paper display. In various examples, the electronic paper display is a multi-stable display.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a schematic diagram of an example system comprising a display device which comprises an electronic paper display and a security module;

FIG. 2 is a schematic diagram showing three example embodiments of the display device in FIG. 1 in more detail;

FIG. 3 is a schematic diagram showing the printer device in FIG. 1 in more detail;

FIG. 4 is a flow diagram and message flow showing an example security method which may be implemented in the system shown in FIG. 1;

FIG. 5 is a flow diagram showing another example security method which may be implemented in the system shown in FIG. 1;

FIG. 6 is a flow diagram showing a further example security method which may be implemented in the system shown in FIG. 1; and

FIG. 7 illustrates various components of an exemplary computing-based device which may implement the content service shown in FIG. 1.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, current e-reader devices often use an electronic paper (e.g. a bi-stable) display because they have much lower power consumption than backlit LCD/LED displays which require power to be able to display anything. In contrast, a bi-stable display requires power to change state (i.e. change the image/text displayed) but not to maintain a static display. However, despite the difference in display technologies used by e-reader devices and tablet computers, the hardware architecture is very similar. Both types of device contain a battery, a processor, a communications module (which is usually wireless) and user interaction hardware (e.g. to provide a touch-sensitive screen and one or more physical controls such as buttons).

Current e-reader devices have a clear owner and the display is part of a computing device which may be secured. In various examples a user may authenticate (e.g. log on to) the e-reader device or to software (e.g. an application or web service) which pushes content to a specific e-reader device. As electronic paper displays become more widely used, they may be treated more like physical paper in that they do not have a single owner and/or have the capability for a user to authenticate directly with the display device. This opens up the possibility that malicious entities may write content to a display device unless security schemes are developed to combat this even for display devices with limited processing capabilities and/or user input capabilities (i.e. such that a user cannot authenticate with the display device).

Since the device cannot be authenticated to a single user, this has implications. Firstly, to update a device, another type of permission than “ownership of device” may be established. The methods described below establish “physical possession of device” though proximity-based networking, and also, in various examples, “ownership of the content being displayed on the device” (if its user X's content, then user X may update it). Secondly, since a device may have multiple users, no user should be allowed to perform a retrieval e.g. “show me what was previously on the device” as this may contain private information of another user. Therefore (a) the backend services for the device do not permit this kind of query, but instead may permit the query “show me content that I have permission to, which was shown on device X” and (b) when a device is updated, the user is able to subsequently rely on the fact that the history of what it previously displayed is deleted from the device, so a subsequent user cannot retrieve this from the device memory itself (the two events ‘update’ and ‘delete’ may not be simultaneous as a short-term “undo” functionality may be implemented).

The embodiments described below are not limited to implementations which solve any or all of the disadvantages of known ways of updating content displayed on an electronic paper display.

Described herein is a method of controlling the updating of content displayed (i.e. rendered) on a display device which comprises an electronic paper display (e.g. a multi-stable display). To control whether a device (e.g. a content providing device) is able to update the displayed content on the electronic paper display, the display device stores and/or generates a value (which may be referred to as a security parameter) that is periodically updated (where this value may, for example, be a random string, number or encryption key). The value may, for example, be updated based on the passage of time (e.g. every minute, every five minutes, etc.) or the receipt of requests (e.g. such that each value is a one-time-use token). The value (i.e. the current value of the security parameter) is communicated to a proximate device and subsequently verified before the displayed content (on the electronic paper display) is updated. In various examples, the verification may be performed by a remote content service and/or the display device.

Using the hardware and methods described herein a user in physical proximity to the display device comprising the electronic paper display can update the content on the device but other users cannot. This may form part of a security policy or it may be combined with other properties to form a security policy (e.g. a specified owner of a device may always be able to update it, even when remote from the device).

In various examples the display device may not include a battery (or other power source) which is capable of updating the electronic paper display. Such a display device therefore requires an intermediary device, referred to as a ‘printer device’, to provide the power to update the electronic paper display and the power is provided via a contact-based bus (as described in more detail below).

In various examples, the communication of the value (i.e. the security parameter) from the display device to a proximate device may use a technique that consumes little or no power on the display device (e.g. an NFC reader within the proximate device or a visual pattern on the electronic paper display).

The term ‘electronic paper’ is used herein to refer to display technologies which reflect light (like paper) instead of emitting light like conventional LCD or LED displays. As they are reflective, electronic paper displays do not require a significant amount of power to maintain an image on the display and so may be described as persistent displays. A multi-stable display is an example of an electronic paper display. In some display devices, an electronic paper display may be used together with light generation in order to enable a user to more easily read the display when ambient light levels are too low (e.g. when it is dark). In such examples, the light generation is used to illuminate the electronic paper display to improve its visibility rather than being part of the image display mechanism and the electronic paper does not require light to be emitted in order to function.

The term ‘multi-stable display’ is used herein to describe a display which comprises pixels that can move between two or more stable states (e.g. a black state and a white state and/or a series of grey or colored states). Bi-stable displays, which comprise pixels having two stable states, are therefore examples of multi-stable displays. A multi-stable display can be updated when powered, but holds a static image when not powered and as a result can display static images for long periods of time with minimal or no external power. Consequently, a multi-stable display may also be referred to as a ‘persistent display’ or ‘persistently stable’ display.

The electronic paper displays described herein may be reflective bit-mapped/pixelated displays which provide a 2D grid of pixels to enable, arbitrary content to be displayed. Such displays are distinct from segmented displays in which there are a small number of segments and only limited types content can be displayed.

In various examples, the display devices 106 described below may be described as ‘non-networked displays’ because whilst they can maintain an image without requiring significant power, they have no automatic means of updating their content other than via the method described herein.

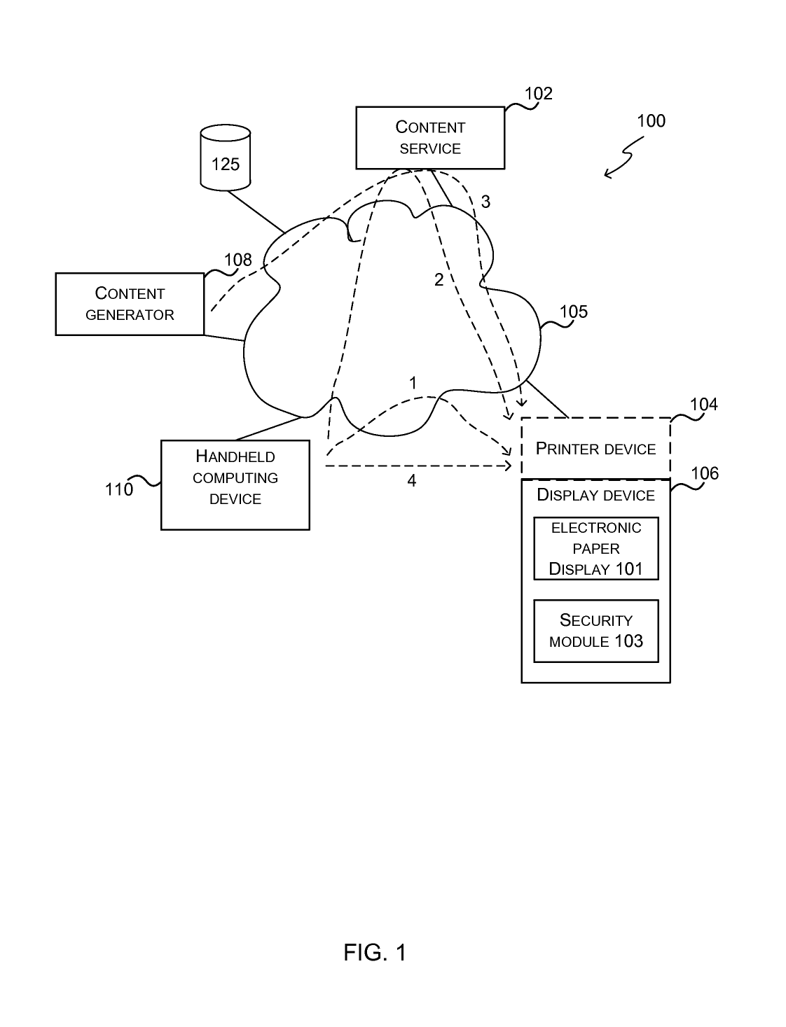

FIG. 1 also shows a schematic diagram of an example system 100 in which the various security schemes described below may be implemented. The system 100 comprises a display device 106 which comprises an electronic paper display 101 (e.g. a multi-stable display), an input for receiving updated content for display on the electronic paper display and a security module 103.

In the example shown in FIG. 1, the display device 106 does not include a battery (or other power source) which is capable of updating the electronic paper display 101 (i.e. it does not include a battery or other power source which provides sufficient power to update the electronic paper display). Instead, power to update the electronic paper display 101 is provided by a printer device 104 via a contact based conductive digital data and power bus when the display device 106 is in physical contact with (and correctly aligned to) the printer device 104 (e.g. when contacts on the display device are touched against corresponding contacts on the printer device). However, in other examples where the display device 106 does include a battery (or other power source) which is capable of updating the electronic paper display 101, the printer device 104 may be omitted.

Where a printer device 104 is used to provide power to update the electronic paper display 101, the digital data and power bus is described as being contact based and conductive because signals for the digital data and power bus are not provided via a cable (which may be flexible), but instead the display device comprises a plurality of conductive contacts (e.g. metal contacts) on its housing (e.g. on an exterior face of the housing) which can be contacted against a corresponding set of conductive contacts on the housing of a printer device. For example, the plurality of conductive contacts may be on a visible face of the display device (e.g. the front, back or side of the printer device) and may be contacted against a corresponding set of conductive contacts on a visible face of the printer device or within a recess (e.g. a slot) on the printer device, such that an edge of the display device is pushed into the recess so that the contacts on the printer and display devices can make contact with each other. The display device is not permanently connected to a printer device but is, instead, intermittently connected (e.g. hourly, daily, weekly, etc. depending on when new content is desired or available).

In addition to providing power to enable the electronic paper display 101 to be updated, the printer device 104 (where provided) also uploads content to the display device 106 (for rendering on the electronic paper display 101) via the contact-based bus, where this content may be received by the printer device 104 via a network 105 (as indicated by arrows 1-3) or directly from a computing device (e.g. handheld computing device 110, as indicated by arrow 4). In systems which do not include a printer device 104, the display device 106 may receive content via the network 105 (as indicated by arrows 1-3) or directly from a computing device (e.g. handheld computing device 110, as indicated by arrow 4).

Where content is provided to the display device 106 (directly or via a printer device 104) by a content service 102, the content may be generated by any computing device and two examples are shown in FIG. 1: a handheld computing device 110 and a content generator device 108. The generation of content (by either device) may be automatic or under the control of a user and in various examples, the generated content may be stored in an accessible location connected to the network 105 (e.g. in a cloud-based content store 125).

Whilst the content generating devices 108, 110 and content service 102 are shown separately in FIG. 1, in some examples, the content service 102 may also act as a content generator (e.g. a single application may enable a user to generate, or compile, content and then trigger the sending of the content to a printer device for uploading to a display device comprising an electronic paper display). Additionally, although the content store 125 is shown separately from the handheld computing device 110, the content generator 108 and the content service 102, in some examples, the content store 125 may be collocated with the content generator 108 (e.g. it may be part of the content generator device 108) and/or the content service 102 (e.g. it may be part of the device which runs the content service). In an example, an application running on the handheld computing device 110 may act as a content generator and content service 102 and a memory on the handheld computing device 110 may be the content store 125. Furthermore, although FIG. 1 shows a single content store 125, it will be appreciated that there may be more than one content store (e.g. a content store on the content generator device 108, a separate content store, a content store on the handheld computing device 110, etc.).

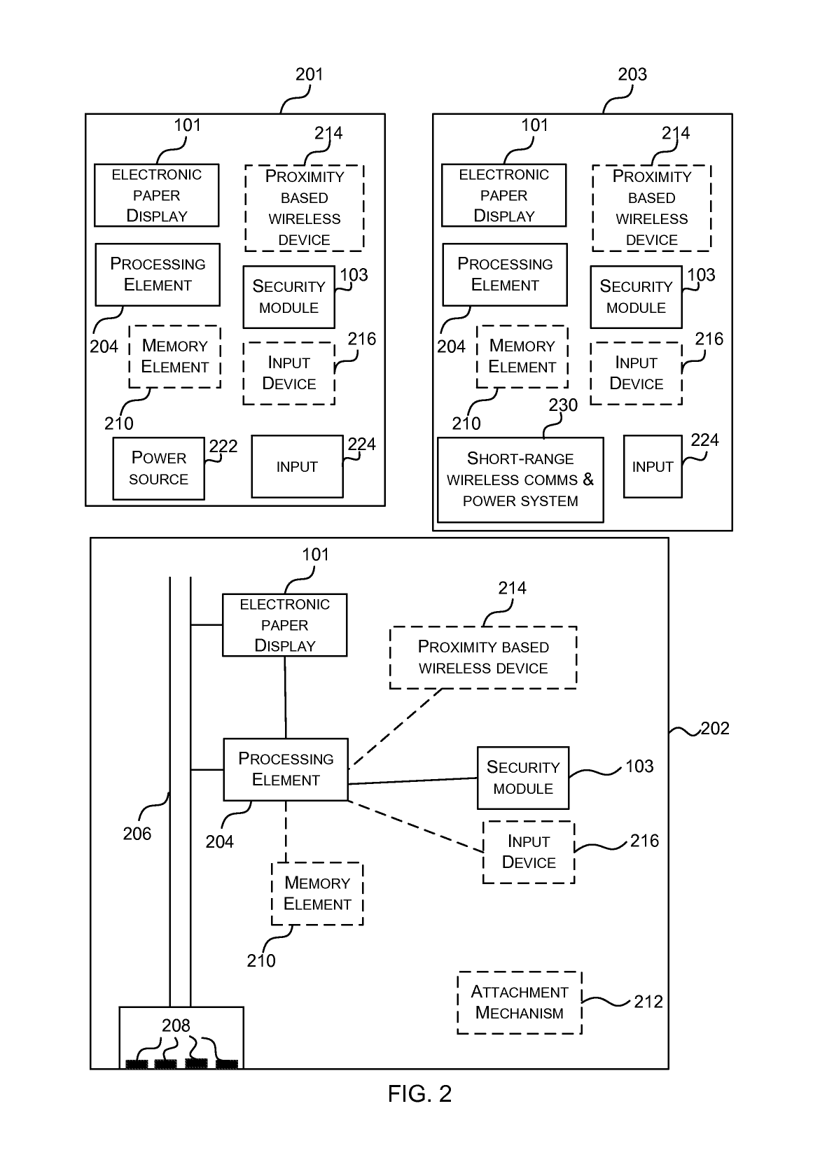

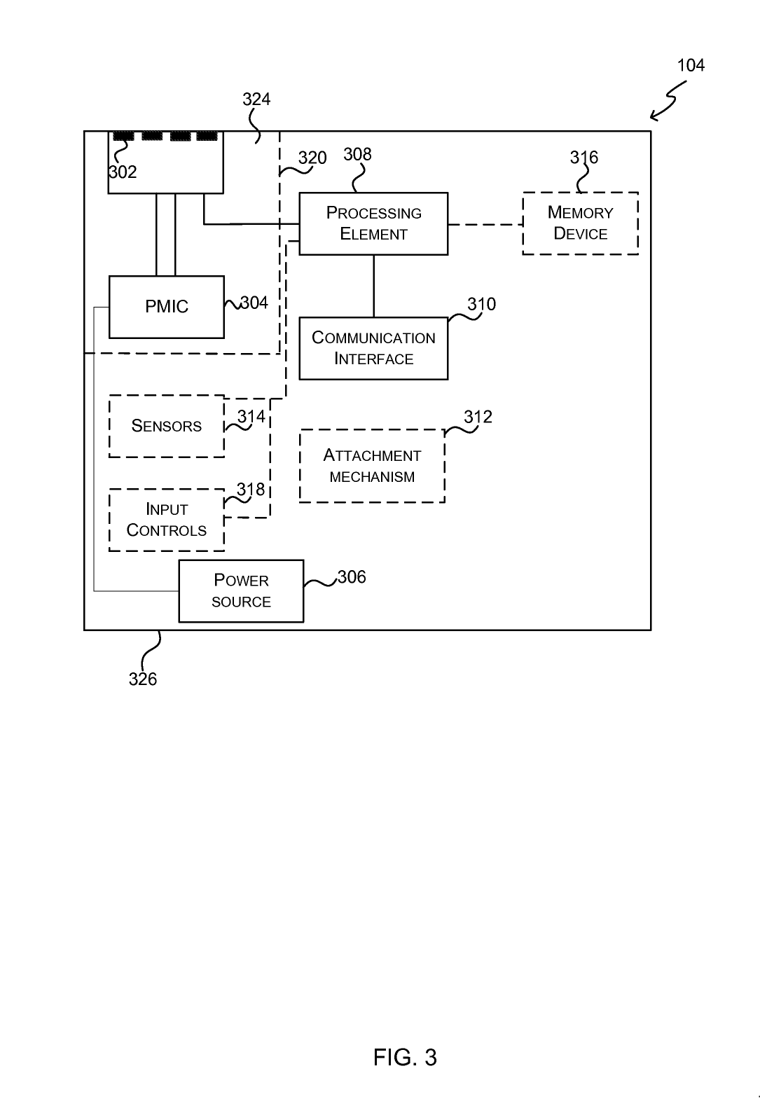

FIG. 2 is a schematic diagram showing three example implementations of the display device 106 from system 100 in more detail. In the first example the display device 201 includes a power source 222 which is capable of updating the electronic paper display and in the second and third examples the display device 202, 203 does not include a power source which is capable of updating the electronic paper display and hence requires a printer device 104 as shown in FIG. 3.

The display device 201-203 comprises an electronic paper display 101, a processing element 204, a security module 103 and an input 224, 208 for receiving updated content for display on the electronic paper display. The second example 202 additionally comprises a contact based conductive digital data and power bus 206. As described above, the bus 206 connects the processing element 204 to a plurality of conductive contacts 208 on the exterior of the housing of the display device 106 (and which therefore comprise the input for receiving updated content). The display device 202 does not comprise a power source which is capable of updating the electronic paper display 101 and power for updating the electronic paper display is instead provided via the bus from a power source 306 in the printer device 104. The third example 203 additionally comprises a short range (e.g. sub-30 cm) wireless communication and power system 230 which is capable of harvesting power from a proximate device (e.g. using NFC) but does not require the two devices to be in physical contact (as is the case in the second example which only receives power for updating the electronic paper display via the contact based conductive digital data and power bus 206). In a further variation, not shown in FIG. 2, the display device 106 may receive power via a wired connection (e.g. a USB connection) from a separate printer device, where the wired connection may be via a flexible cable or a rigid connector which is integrated with the display device.

Although the security module 103 is shown as a separate element in the display device 201-203, in various examples it may be implemented as part of the processing element 204. In the second and third examples 202, 203, the security module 103 may, in various examples, only be operable (e.g. to perform value generation, verification, encryption and/or decryption) when receiving power via the contact based bus. In other examples, some of the functionality of the security module 103 (e.g. decryption) may only be enabled when receiving power via the contact based bus (in example 202) or short-range wireless communication and power system 230 (in example 203) and other functionality may be enabled even when not receiving power via the contact based bus or short-range wireless communication and power system 230 (e.g. when receiving power through other means or using an internal power source which is not capable of updating the electronic paper display).

The electronic paper display 101 may use any suitable technology, including, but not limited to: electrophoretic displays (EPDs), electro-wetting displays, bi-stable cholesteric displays, electrochromic displays, MEMS-based displays, etc. and some of these technologies may provide multi-stable displays. In various examples, the display has a planar rectangular form factor; however, in other examples the electronic paper display 101 may be of any shape and in some examples may not be planar but instead may be curved or otherwise shaped (e.g. to form a wearable wrist-band). In various examples, the electronic paper display 101 may be formed on a plastic substrate which may result in a display device 201-203 which is thin (e.g. less than one millimeter thick) and has some flexibility. Use of a plastic substrate makes the display device 201-203 lighter, more robust and less prone to cracking of the display (e.g. compared to displays formed on a rigid substrate such as silicon or glass).

The processing element 204 may comprise any form of active (i.e. powered) sequential logic (i.e. logic which has state), such as a microprocessor, microcontroller, shift register or any other suitable type of processor for processing computer executable instructions to drive the electronic paper display 101. The processing element 204 comprises at least the row & column drivers for the electronic paper display 101; however, in various examples, the processing element 204 comprises additional functionality/capability. For example, the processing element 204 may be configured to demultiplex data received (e.g. via the input 222, the bus 206 or short-range wireless communication and power system 230) and drive the display 101.

In various examples the processing element 204 may comprise one or more hardware logic components, such as Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs) and Graphics Processing Units (GPUs).

In various examples, the processing element 204 may comprise (or be in communication with) a memory element 210 which is capable of storing data for at least a sub-area of the display 101 (e.g. one row and column of data for the display 101) and which in some examples may cache more display data. In various examples the memory element 210 may be a full framebuffer to which data for each pixel is written before the processing element 204 uses it to drive the row/column drivers for the electronic paper display. In other examples, the electronic paper display may comprise a first display region and a second display region which may be updated separately (e.g. the second display region may be used to show icons or user-specific content) and the memory element may be capable of storing data for each pixel in one of the display regions.

In various examples, the memory element 210 may store other data in addition to data for at least a sub-area of the display 101 (e.g. one row and column of the display). In various examples, the memory element 210 may store an identifier (ID) for the display device 201-203. This may be a fixed ID such as a unique ID for the display device 201-203 (and therefore distinct from the IDs of all other display devices 201-203) or a type ID for the display device (e.g. where the type may be based on a particular build design or standard, electronic paper display technology used, etc.). In other examples, the ID may be a temporary ID, such as an ID for the particular session (where a session corresponds to a period of time when the display device is continuously connected to a particular printer device) or for the particular content being displayed on the display device (where the ID may relate to a single page of content or a set of pages of content or a particular content source). In various examples, a temporary ID may be reset manually (e.g. in response to a user input) or automatically in order that a content service does not associate past printout events on a display device with current (and future) printouts, e.g. to disable the ability for a user to find out the history of what was displayed on a display device which might, for example, be used when the display device is given to another user. The ID which is stored may, for example, be used to determine what content is displayed on the display device and/or how that content is displayed (as described in more detail below).

In various examples, the memory element 210 may store parameters relating to the electronic paper display 101 such as one or more of: details of the voltages required to drive it (e.g. the precise value of a fixed common voltage, Vcom, which is required to operate the electronic paper display), the size and/or the resolution of the display (e.g. number of pixels, pixel size or dots per inch, number of grey levels or color depth, etc.), temperature compensation curves, age compensation details, update algorithms and/or a sequence of operations to use to update the electronic paper display (which may be referred to as the ‘waveform file’), a number of update cycles experienced, other physical parameters of the electronic paper display (e.g. location, orientation, position of the display relative to the device casing or conductive contacts), the size of the memory element, parameters to use when communicating with the electronic paper display, etc. These parameters may be referred to collectively as ‘operational parameters’ for the electronic paper display. The memory element 210 may also store other parameters which do not relate to the operation of the electronic paper display 101 (and so may be referred to as ‘non-operational parameters’) such as a manufacturing date, version, a color of a bezel of the display device, etc.

Where the memory element 210 stores an ID or parameters for the electronic paper display, any or all of the stored ID and parameters may, in the second example 202, be communicated to a connected printer device 104 via the bus 206 and contacts 208 by the processing element 204. The printer device 104 may then use the data received to change its operation (e.g. the voltages provided via the bus or the particular content provided for rendering on the display) and/or to check the identity of the display device 106. In any of the three examples, the ID may be communicated to the content service 102.

In various examples, the memory element 210 may store computer executable instructions which are executed by the processing element 204 (e.g. when power is provided via the bus 206 in the second example 202 or the short-range wireless communication and power system 230 in the third example 203). The memory element 210 includes volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media.

The security module 103 may be implemented in various different ways depending upon the security scheme (or method) used. In all examples, however, the security module 103 stores and/or generates a value that is periodically updated and which is verified before the content displayed on the electronic paper display 101 is updated. The verification may, for example, be performed by the display device 201-203 and/or the content service 102 (and/or by other elements within the system 100 shown in FIG. 1). Where the security module 103 generates a value which is periodically updated this value may be generated from a stored constant and these generated values may be stored (albeit briefly in various examples) within the security module 103. As described above, this value that is periodically updated may be referred to as a security parameter or security token.

Where the display device 201-203 performs the verification, this may be performed by the security module 103. In various examples, the security module 103 may comprise a trusted platform module (TPM) or a one-time-token generator. In examples where the security module 103 comprises a TPM, the content and/or the value may be encrypted when sent to/from the display device 201-203 and this ensures that untrusted parties cannot eavesdrop. As described above, the value is periodically updated and so any description of the security module 103 communicating the value to a proximate device refers to the communication of the current value (rather than a previous value that has subsequently been replaced when updating occurs).

In various examples, the second example display device 202 may further comprise an attachment mechanism 212 which is configured to hold the display device 202 in contact with a printer device when a user has brought the two devices into contact with each other. This attachment mechanism 212 may, for example, use one or more ferromagnetic elements in one or both of the display device 202 and the printer device 104. In addition to, or instead of, using ferromagnetic elements, the attachment mechanism may use suction cup tape, friction (e.g. with the display device being partially inserted into a slot or recess on the printer device) or a clamping arrangement.

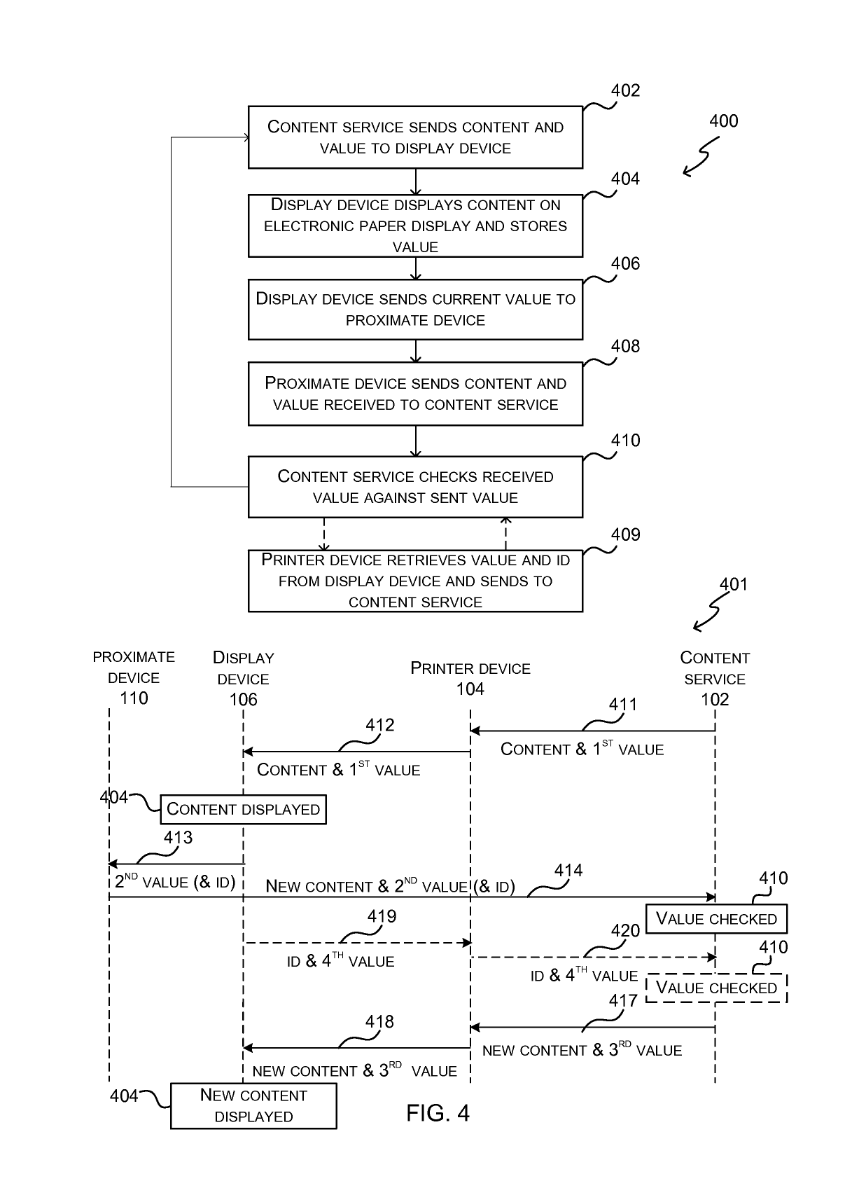

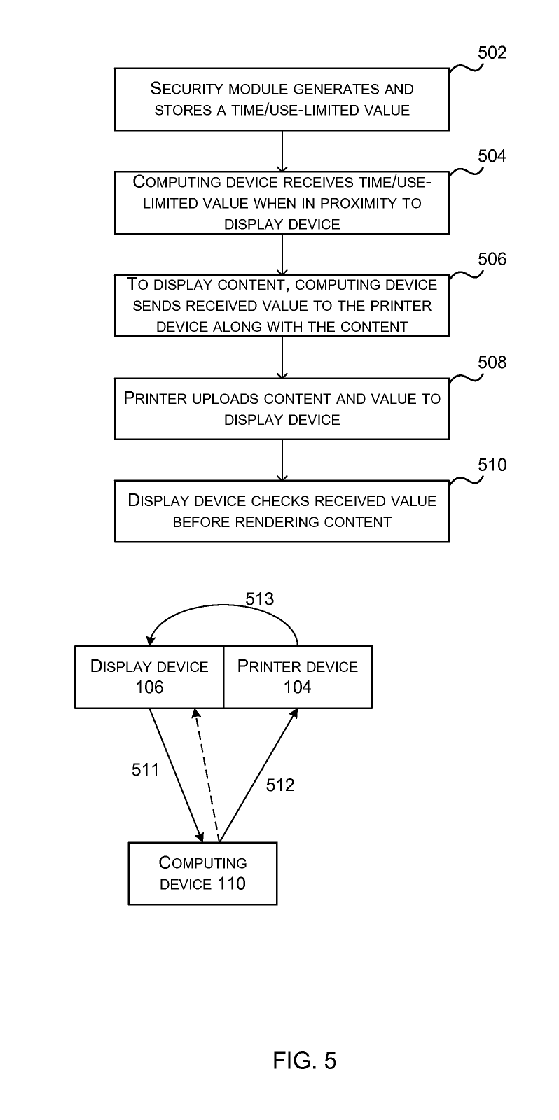

In various examples, the display device 201-203 may further comprise a proximity based wireless device 214, such as a near field communication (NFC) device and in the third example, the proximity based wireless device 214 may be part of (or comprise) the short range wireless communication and power system 230. The proximity based wireless device 214 (where provided) comprises a data communication interface (e.g. an I²C interface, SPI, an asynchronous serial interface, etc.) and an antenna and may also comprise a memory device. As described in more detail below with reference to FIGS. 4 and 5, the proximity based wireless device 214 may be used to share the value stored by the security module 103 with a proximate device (e.g. handheld computing device 110 in FIG. 1). Where the second example display device 202 comprises a proximity based wireless device 214, this wireless device is not used to provide power to update the electronic paper display (i.e. energy harvesting is not used to provide power to update the electronic paper display in the second example 202).

In various examples, the display device 201-203 may further comprise one or more input devices 216. An input device 216 may, for example, be a sensor (such as a microphone, touch sensor or accelerometer) or button. In the second and third examples, 202, 203, such input devices 216 are only operational (i.e. powered) when the display device 202 is in contact with a printer device 104 such that power is provided via the bus 206 or when the display device 203 is receiving power via the short-range wireless communication and power system 230. Where the display device 201-203 comprises an input device 216, signals generated by the input device 216 may be interpreted by the processing element 204 and/or communicated to a remote processing device (e.g. in a printer device 104 in the case of the second example 202). User inputs via an input device 216 may, for example, be used to modify the content displayed on the electronic paper display 101 (e.g. to annotate it, change the font size, trigger the next page of content to be displayed, etc.) or to trigger an action in a remote computing device.

In an example, the display device 201-203 comprises an input device 216 which is a touch-sensitive overlay for the electronic paper display 101. The touch-sensitive overlay may, for example, use pressure, capacitive or resistive touch-sensing techniques. In the second and third examples, when the display device 202, 203 is powered via the bus (i.e. when it is in contact with a printer device 104) or the short-range wireless communication and power system 230, the touch-sensitive overlay may be active and capable of detecting touch events (e.g. as made by a user's finger or a stylus touching the electronic paper display 101). In the first example 201 the overlay may be active at any time. The output of the touch-sensitive overlay is communicated to the processing element 204 or printer device 104 (in the second example 202) or content service which may modify the displayed image (on the electronic paper display 101) to show marks/annotations which correspond to the touch events. In other examples, the processing element 204 may modify the displayed image in other ways based on the detected touch-events (e.g. through the detection of gestures which may, for example, cause a zoom effect on the displayed content).

In another example, the display device 106 comprises an input device 216 which is a microphone. The microphone detects sounds, including speech of a user and these captured sounds may be detected by the processing element 204 or printer device or content service and translated into changes to the displayed image (e.g. to add annotations or otherwise change the displayed content). For example, simple keyword detection may be performed on the processing element to cause it to fetch content from memory and write it to the electronic paper display. In another example, the processing element may interpret or transform the audio data and ship it out to the printer device or a remote server for more sophisticated processing. In another example, the recorded sounds (e.g. speech waveform) may be recorded and stored remotely (e.g. in a content service) associated with the ID of the display device and a visual indication may be added to the displayed content so that the user knows (e.g. when they view the same content later on) that there is an audio annotation for the content.

In various examples, the display device 201-203 may comprise a touch-sensitive overlay and a microphone which operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

Where provided, the printer device 104, as shown in FIG. 3, comprises a plurality of conductive contacts 302 and a power management IC (PMIC) 304 which generates the voltages that are provided to bus of the display device (via contacts 302). The PMIC 304 is connected to a power source 306 which may comprise a battery (or other local power store, such as a fuel cell or supercapacitor) and/or a connection to an external power source. Alternatively, the printer device 104 may use an energy harvesting mechanism (e.g. a vibration harvester or solar cell).

The printer device 104 further comprises a processing element 308 which provides the data for the bus of the display device, including the pixel data. The processing element 308 in the printer device 104 obtains content for display from the content service 102 or a content generating device 108, 110 via a communication interface 310 and may also obtain one or more operational parameters for different display devices from the content service 102 (where implemented). The communication interface 310 may use any communication protocol and in various examples, wireless protocols such as Bluetooth™ or WiFi™ or cellular protocols (e.g. 3G or 4G) may be used and/or wired protocols such as USB or Ethernet may be used. In some examples, such as where the communication interface uses USB, the communication interface 310 may be integrated with the power source 306 as a physical connection to the printer device 104 may provide both power and data.

The processing element 308 may, for example, be a microprocessor, controller or any other suitable type of processor for processing computer executable instructions to control the operation of the printer device in order to output pixel data to a connected display device 106. In some examples, for example where a system on a chip architecture is used, the processing element 308 may include one or more fixed function blocks (also referred to as accelerators) which implement a part of the method of providing pixel data in hardware (rather than software or firmware). The processing element 308 may comprise one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The printer device 104 may comprise an attachment mechanism 312, such as one or more ferromagnetic elements or a slot to retain the display device. This attachment mechanism 312 may, in various examples, incorporate a sensor 314 (which may be implemented as a sensing electronic circuit) to enable the printer device 104 to determine the orientation of a display device when in contact with the printer device 104 and/or whether a display device is in contact or not.

In various examples, the processing element 308 may comprise (or be in communication with) a memory device (or element) 316. In various examples, the memory element 316 may store an identifier (ID) for the printer device 104. This may be a fixed ID such as a unique ID for the printer device 104 (and therefore distinct from the IDs of all other printer devices 104) or a type ID for the printer device (e.g. where the type may be based on a particular build design or standard, etc.). In other examples, the ID may be a temporary ID, such as an ID for the particular session (where a session corresponds to a period of time when the display device is continuously connected to a particular printer device) or for the particular content being displayed on a connected display device (where the ID may relate to a single page of content or a set of pages of content or a particular content source).

In various examples, the memory element 316 may store operational parameters for one or more different electronic paper displays, where these operational parameters may be indexed (or identified) using an ID for the display device (e.g. a unique ID or a type ID). Where operational parameters are stored in the memory element 316 these may be copies of parameters which are stored on the display device, or they may be different parameters (e.g. voltages may be stored on the display device and a waveform for driving the display device may be stored on the printer device because it occupies more memory than the voltages) or there may not be any operational parameters stored on the display device. In addition, or instead, the memory element may store parameters associated with printer device, such as its location (e.g. kitchen, bedroom, etc.) and additional connected devices (e.g. a music player through which audio can be played, etc.).

In various examples, the memory element 316 may act as a cache for the content (or image data) to be displayed on a connected display device. This may, for example, enable content to be rendered more quickly to a connected device (e.g. as any delay in accessing the content service 102 may be hidden as pages are cached locally in the memory element 316 and can be rendered whilst other pages are being accessed from the content service 102) and/or enable a small amount of content to be rendered even if the printer device 104 cannot connect to the content service 102 (e.g. in the event of connectivity/network problems).

The memory element 316 may, in various examples, store computer executable instructions for execution by the processing element 308. The memory element 316 may include volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 316) is shown within the printer device 104 it will be appreciated that the storage may be distributed or located remotely and accessed via a network or other communication link (e.g. using communication interface 310).

As described above, the printer device 104 may comprise a sensor 314 configured to detect whether a display device is in contact with the printer device 104 or is electrically connected via the contacts 302. In addition or instead, one or more other sensors may be provided within the printer device 104, such as an accelerometer (e.g. for sensing motion of or the orientation of the printer device 104) and/or a sensor for detecting a proximate handheld computing device (e.g. a smartphone or tablet computer).

In various examples, the printer device 104 may comprise one or more user input controls 318 which are configured to receive user inputs. These user inputs may, for example, be used to change what is displayed on a connected display device (e.g. to select the next page within a piece of content or the next piece of content). For example, the printer device 104 may comprise one or more physical buttons. In various examples, one or more physical buttons may be provided which are mapped to specific content (e.g. when pressing a particular button, a photo ID badge will always be rendered on the connected display). These buttons may have fixed functions or their functions may change (e.g. based on the content displayed or the display device connected). In some examples, the processing element 308 may render icons adjacent to each button on the electronic paper display, where an icon indicates the function of the adjacent button. In such an example, the pixel data provided to the display device (via contacts 302) is a composite image which combines the content to be displayed and one or more icons for buttons (or other physical controls) on the printer device 104. In other examples, the composite image may be generated by the content service 102.

In an example, the printer device 104 comprises an input control (or device) 318 which detects a user touching a connected display device with their finger or a stylus. This may, for example, comprise an electromagnetic sensing backplane (e.g. using electric field sensing) in the face of the printer device which is adjacent to a connected display device or may be implemented using force sensors (e.g. four sensors at the corners and where interpolation is used to calculate the touch point position) or active digitizer pens. Alternatively, optical or ultrasonic methods may be used (e.g. to look along the top surface. Where ultrasonics are used, these may additionally be used to provide haptic feedback to the user. The output of the touch input control is communicated to the processing element 308 or to the content service which may modify the content and then provide the modified content to the display device (so that it is displayed on the electronic paper display 106) to show marks/annotations which correspond to the touch events. In other examples, the processing element 308/content service may modify the displayed image in other ways based on the detected touch-events (e.g. through the detection of gestures which may, for example, cause a zoom effect on the displayed content or through provision of feedback in other ways, e.g. using audio or vibration or by selectively backlighting the electronic paper display using one or more lightpipes).

In various examples, the printer device 104 comprises an input device which is a microphone. The microphone detects sounds, including speech of a user and these captured sounds may be detected by the processing element or content service and translated into changes to the displayed image (e.g. to add annotations or otherwise change the displayed content). In another example, the recorded sounds (e.g. speech waveform) may be recorded and stored remotely (e.g. in a content service) associated with the ID of the display device and a visual indication may be added to the displayed content so that the user knows (e.g. when they view the same content later on) that there is an audio annotation for the content.

In various examples, the printer device 104 may comprise a sensing backplane and a microphone which operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

The printer device 104 may have many different form factors. In various examples it is standalone device which comprises a processing element 308 and communication interface 310 in addition to a PMIC 304 and a plurality of conductive contacts 302 to provide the signals for the digital data and power bus 206 within a display device. In other examples, however, it may be a peripheral for a computing device and may utilize existing functionality within that computing device which may, for example, be a portable or handheld computing device (e.g. a smartphone, tablet computer, handheld games console, etc.) or a larger computing device (e.g. a desktop computer or non-handheld games console). Where the printing device 104 is implemented as a peripheral device, the functionality shown in FIG. 3 may be split along the dotted line 320 such that the PMIC 304 and conductive contacts 302 are within the peripheral 324 and the remaining elements (in portion 326) are within the computing device and may utilize existing elements within that computing device. In further examples, the entire printer device 104 may be integrated within a computing device.

FIG. 4 is a flow diagram 400 and a message flow 401 showing a first example security scheme which may be implemented to control the updating of content displayed on the electronic paper display 101 in the display device 106, 201-203 described above. Whilst the message flow 401 shows a printer device 104, as described above the security scheme may also be applied where the display device 106, 201 includes a power source which is capable of updating the electronic paper display 101 or where the display device 106, 203 includes a short-range wireless communication and power system 230 and in which case the printer device 104 is omitted. As shown in FIG. 4, a content service 102 sends a value (the first value) along with content to be displayed to a display device (block 402 and arrows 411, 412). This value may, for example, be a random string or numerical value. The receiving display device 106, 201-203 stores the received value as a new security parameter (e.g. in the security module 103) and displays the content on the electronic paper display device 101 (block 404). The display device 106, 201-203 may subsequently provide the current security parameter (the second value) to a proximate content providing device 110 (block 406 and arrow 413). The current security parameter (i.e. the second value) may be the same as the value received previously from the content service 102 (i.e. the first and second values may be the same) or the current security parameter may have been derived from the value received (e.g. the first and second values may have a known mathematical relationship such as one being the result of a hash function applied to the other). The display device 106, 201-203 may also provide additional information to the proximate device 110, such as an identifier for the display device.

In order communicate with a proximate device, a proximity based wireless device 214 may, for example, be provided in the display device 106 and may be used to make the current time-limited or use-limited value available to a proximate computing device which has a compatible proximity based wireless device (e.g. an NFC reader that can read the value from an NFC tag in the display device). Alternatively, the image displayed on the electronic paper display may include a visual code which encodes the current time-limited or use-limited value (e.g. in the form of a QR code).

In order to render content on the electronic paper display 101, the proximate device 110 sends the value received (e.g. the second value) along with the content to be displayed to the content (and the display device ID if received) to the content service 110 in a request to update content on the particular display device (block 408 and arrow 414). The value received by the content service 110 is verified (block 410) against the previously sent value (in block 402). This verification (in block 410) may comprise checking that the received value is the same as the sent value (e.g. where the first and second values are the same) or otherwise checking that the second value is consistent with (or corresponds to) the first value. Irrespective of the method used to generate the second value, the content service 102 verifies that the value received from the proximate device 110 is the same as the value that should have been provided by the display device to a proximate device given that the display device had received the first value from the content service.

If the verification (in block 410) is successful, the content service 102 can send the content received from the proximate device 110 (in block 408) to the display device along with a new value (block 402 and arrows 417 and 418). This new content may be pushed to the display device or alternatively it may only be provided (in block 402) in response to a request from the display device or a printer device. In a system which uses a printer device 104 and where the printer device is untrusted, a further verification (in a repeat of block 408) may be performed before sending the new content to the display device (in block 402). For example, the printer device 104 may retrieve the current security parameter (the fourth value) and the display device ID from the display device 106 (arrow 419) and send this to the content service 102 (block 409 and arrow 420). The value sent by the printer device 104 (the fourth value) may be the same as the value previously received from the content service (the first value) and/or the same as the value previously provided to the proximate device (the second value) or it may be a different value which has been derived from the value previously received from the content service (the first value). In this second verification stage, the value received by the content service 110 from the printer device 104 is verified (in block 410) against the previously sent value (in block 402), e.g. as described above.

Using this method, a computing device cannot provide content which is displayed on the display device unless it is (or has recently been) in proximity to the display device. Furthermore, where the optional block 409 is implemented, a printer device cannot request an update to content for a display device which is not connected to the printer device (because the printer device needs to know the current stored value on the display device in order for the check between the first and fourth values in block 410 to succeed) and a display device cannot request an update to content which is displayed on another display device (because it will not be storing the correct first value and the check between the first and fourth values in block 410 will fail).

As described above, the value which is communicated to the content service by the proximate device (in block 408 and arrow 414) and/or the printer device (in block 409 and arrow 420) may not be identical to that received with the content (i.e. the received value may not be identical to the first value which is sent in block 402). Instead the received (or first) value may be modified by the display device based on a secret known to both the content service and the display device (e.g. using a pre-defined algorithm and/or a modifier value) to generate a derived (e.g. second and/or fourth) value. In another example, the content service may previously have provided a list of values to display device and in response to receiving the first value, the display device may update the current security parameter to the next value in the list of values. In this example, and in a system comprising a printer device 104, even if the printer device caches the value received (i.e. the first value) along with the content (arrow 411) it cannot receive the new content unless the correct display device is in contact with the printer device because it will not know the derived (fourth) value.

In a further variation and where a new (third) value is sent by the content source to the display device along with the new content (arrows 417, 418), this new value (the third value) may be generated (by the content source) using the original value (the first value, using the notation from above) and a secret known to both the content source and the display device. This enables the display device to check that the new content and new value (the third value) are valid (i.e. that they were sent by the correct content source) before displaying the new content (in block 404) and storing the third value as the new value in the security module 103. In the event that the check by the display device of the received (third) value fails, the new content is not displayed and the third value is not stored (and instead the security module continues to store the previously stored (first, second or fourth) value).

FIG. 5 is a diagram showing a second example security scheme which may be implemented to control the updating of content displayed on the electronic paper display 101 in the display device 106 described above. As shown in FIG. 5, the security module 103 in the display device 106 generates and stores a time-limited or use-limited value (block 502) which may, for example, be in the form of a random string or numerical value which changes periodically (e.g. every minute or whenever the display device is connected to or detached from a printer device). In this example, as in the previous example shown in FIG. 4, in order for a computing device (such as handheld computing device 110) to be able to send content to the display device to be rendered on the electronic paper display 101, the computing device must be proximate to the display device 106; however, in this example, the value is generated by the security module 103 and not by the content service 102 and in fact the system need not include a content service.

When in the two devices (the computing device 110 and the display device 106) are in close proximity, the computing device can receive the current time-limited or use-limited value from the display device (block 504 and arrow 511). For example, a proximity based wireless device 214 may be provided in the display device 106 and may be used to make the current time-limited or use-limited value available to a proximate computing device which has a compatible proximity based wireless device (e.g. an NFC reader that can read the value from an NFC tag in the display device). Alternatively, the image displayed on the electronic paper display may include a visual code which encodes the current time-limited or use-limited value (e.g. in the form of a QR code).

The computing device sends the received value (from block 504) to the printer device (where provided) along with the content to be displayed (block 506 and arrow 512) and both are uploaded to the display device by the printer device (block 508 and arrow 513). Where the display device includes a power source which is capable of updating the electronic paper display (and hence a printer device is not used), the proximate computing device may send the received value (from block 504) along with the content to be displayed to the display device without going via a printer device (arrow 514). The display device does not display the received content (on the electronic paper display) unless a check of the value received from the printer device or computing device (as performed by the security module 103) confirms that it matches the current stored time-limited or use-limited value (block 510). In this way the display device 106 ensures that only proximate devices can provide content for rendering on the electronic paper display.

Although this example does not show use of a content service 102, it will be appreciated that the method may also be applied in a system where the computing device 110 sends the content and the value to a content service 102 which then provides both the content and the value to the printer device 104 or to the display device 106 (where the system does not include a printer device) and the method continues as described above.

In a variation, however, where a content service is used, the content service 102 may perform the check of the value received from the computing device 110 instead of (or in addition to) the display device performing the check. In such an example, the security module 103 within the display device may generate a time/use-limited value using a technique (e.g. an algorithm and seed value) which is also known to the content service and may be different for different display devices. Consequently, the content service may be able to independently generate the same time/use-limited value as the security module 103 within the display device and check the value provided by the computing device before providing the content to the printer device for uploading to the display device.

In an alternative variation which uses a content service, the display device may provide the time/use-limited value to a proximate device (in block 504) and also transmit the same time/use-limited value to the content service (via the printer device where provided). The content service then checks that the value it receives from the computing device matches the value received from the display device before providing the content received from the computing device to a printer device for uploading to the display device. In another variation, the content service may independently generate the time/use-limited value (e.g. using the same algorithm or technique as the security module 103 in the display device) and then only provide the content received from the computing device to the display device (via a printer device where provided) if two checks are passed—one between the value received from the computing device and the value generated by the content service and the other between the value received from the display/printer device and the value generated by the content service. This ensures not only that the computing device is authorized to “print” to the display device but also that the printer device (where provided) is currently connected to the same display device.

In various examples in which a printer device is used, the reading of the time/use-limited value from the display device (in block 504) may be performed only when the display device is in contact with the printer device. In other examples, however, a computing device may be able to read the time/use-limited value when the display device is not connected to the printer device; however any update to the displayed content can only take place when the display device is subsequently in contact with a printer device. This may result in a delay between the receipt of the time/use-limited value by the computing device (in block 504) and the checking of the value by the display device (in block 510). This does not affect the method where a use-limited value is used; however, for a time-limited value, either the life of the time-limited value is, in this example, defined to be sufficiently long to accommodate this delay or the check may alternatively be performed by a content service (e.g. as described above) or the printer device.

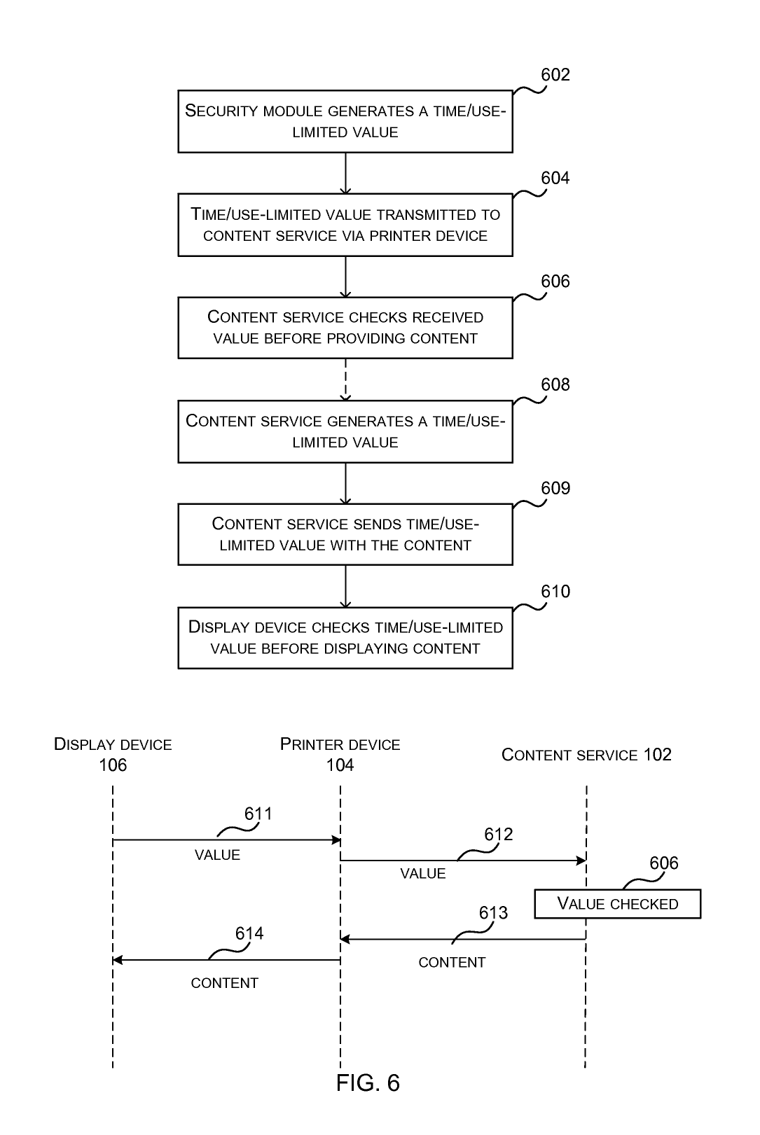

FIG. 6 is a diagram showing a third example security scheme which may be implemented to control the updating of content displayed on the electronic paper display 101 in the display device 106 described above. In this example, the display device 106 does not comprise a power source capable of updating the display device and so a printer device (e.g. as described above) is used to provide power (e.g. via a contact based bus as described above or other short-range power transfer means, such as wireless power harvesting). In this example, a time/use-limited value generated within the security module 103 in the display device 106 (block 602) is used to establish a trust relationship between the display device 106 and the content service 102. The generated time/use-limited value is sent by the display device 106 to the content service 102 via the printer device (block 604 and arrows 611, 612) which is proximate to the display device. The security module 103 uses a technique (e.g. an algorithm and seed value) to generate the time/use-limited value (in block 602) which is also known to the content service and may be different for different display devices. This means that the content service can check (in block 606) that the received value is valid (e.g. that it is the correct value for that time/use and for the particular display device from which it was received) before sending content to the display device (arrows 613, 614).

In an extension of the method of FIG. 6, the content service 102 may also generate a time/use-limited value (block 608) which is different to that generated and sent by the display device to the content service. This content service generated time/use-limited value may be generated using a technique (e.g. an algorithm and seed value) which is also known to the display device (e.g. the same algorithm but different seeds may be used by the content service and the display device to generate the values and both seeds may be known to both the content service and the display device). The content service generated time/use-limited value may be transmitted to the display device 106 along with the content (block 609 and arrows 613, 614) and checked by the security module 103 in the display device before displaying the content (block 610). This means that the content service can check the display device is a valid display device and the display device can check that the content service is a valid content service. Content is not provided by the content service unless the display device is valid and the display device does not render the provided content on the electronic paper display unless the content service is valid.

Aspects of the methods described above may be combined in any way and encryption and/or digital signatures may be also used in combination with any of the examples described above with reference to FIGS. 4-6. By using digital signatures (with the relevant keys being stored within a TPM in the display device), the display device can check that the content was sent by the intended content service and the content service can check that a request for content was sent by the intended display device. By using encryption (again with the relevant keys being stored within a TPM in the display device and the decryption being performed on the display device) intermediary devices (e.g. printer devices) and eavesdroppers cannot access the content.

In an example (which is a variation on that shown in FIG. 5 and described above), a display device 106 may share both its public key and a time/use-limited value with a proximate device using a proximity based wireless device in the display device. The receiving computing device may then use the key received to encrypt the value and/or the content which it transmits to the display device (either directly or via the content service and/or a printer device). The display device can then verify that the value received with the content matches the value provided to a proximate device before displaying the received content on the electronic paper display. In examples where the value is encrypted, an intermediary device or eavesdropping device cannot pretend to be the proximate device and send content to the display device which will then be displayed (as the intermediary/eavesdropping device will not have access to the required value). If both the value and the content are encrypted, it is not necessary to trust any intermediary device (including the content service) in the system as neither the value nor the content can be recovered by any device other than the correct display device.

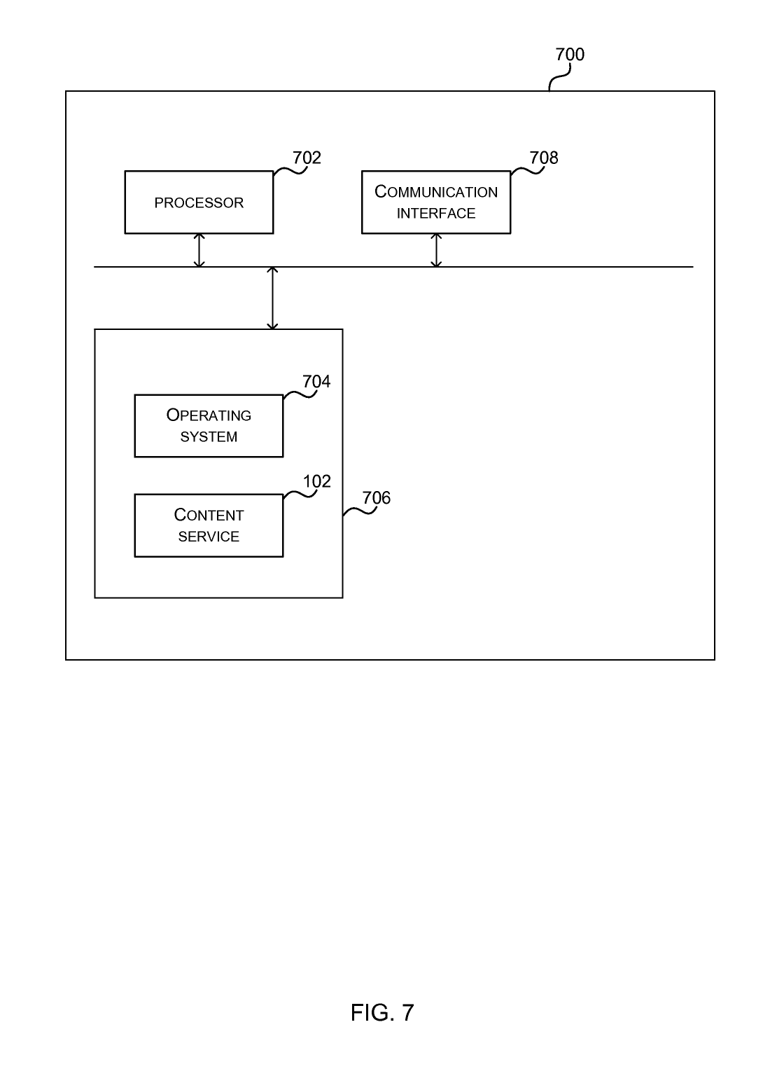

FIG. 7 illustrates various components of an exemplary computing-based device 700 which may be implemented as any form of a computing and/or electronic device, and which may implement the content service 102 as shown in FIG. 1.

Computing-based device 700 comprises one or more processors 702 which may be microprocessors, controllers or any other suitable type of processors for processing computer executable instructions to control the operation of the device in order to act as a content service 102. In some examples, for example where a system on a chip architecture is used, the processors 702 may include one or more fixed function blocks (also referred to as accelerators) which implement a part of the method of operation in hardware (rather than software or firmware. Platform software comprising an operating system 704 or any other suitable platform software may be provided at the computing-based device to enable application software, including the content service 102, to be executed on the device.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The computer executable instructions may be provided using any computer-readable media that is accessible by computing based device 700. Computer-readable media may include, for example, computer storage media such as memory 706 and communications media. Computer storage media, such as memory 706, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 706) is shown within the computing-based device 700 it will be appreciated that the storage may be distributed or located remotely and accessed via a network (e.g. network 105) or other communication link (e.g. using communication interface 708).

The computing-based device 700 may also comprise an input/output controller arranged to output display information to a display device which may be separate from or integral to the computing-based device 700 and/or to receive and process input from one or more devices, such as a user input device (e.g. a mouse, keyboard, camera, microphone or other sensor). In some examples the user input device may detect voice input, user gestures or other user actions and may provide a natural user interface (NUI). The input/output controller may also output data to devices other than the display device.

Any of the input/output controller, display device and the user input device may comprise NUI technology which enables a user to interact with the computing-based device 700 in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in a system as shown in the two examples in FIG. 1, the systems as described is provided as an example and not a limitation. As those skilled in the art will appreciate, the present examples are suitable for application in a variety of different types of systems and a computing device may act as a content generator and a printer device or a content service and content generator, etc. Furthermore, any suitable communication means may be used by the particular elements shown in FIG. 1 to communicate (e.g. point to point links, broadcast technologies, etc.).

A first further example provides a display device comprising: an electronic paper display arranged to display content; a security module arranged to store and/or generate a value that is periodically updated and to communicate the value to a proximate device; an input for receiving content for display on the electronic paper display; and a processing element configured to drive the electronic paper display, wherein a proposed update to the displayed content is accompanied by a further value and the further value is verified by the security module or by a remote content service before updating the content displayed on the electronic paper display.

A second further example provides a display device comprising: an electronic paper display arranged to display content; means for securely storing and/or generating a value that is periodically updated and to communicate the value to a proximate device; means for receiving content for display on the electronic paper display; and means for driving the electronic paper display, wherein a proposed update to the displayed content is accompanied by a further value and the further value is verified by the display device or by a remote content service before updating the content displayed on the electronic paper display.

In the first or second further examples, the input may be arranged to receive content and a value from a content service and wherein the security module is arranged to update the stored value to match the value received and to subsequently communicate a value derived from the stored value to the content service via a proximate device to receive further content.

In the first or second further examples, the security module may be arranged to verify the value received prior to updating the stored value to match the value received.

In the first or second further examples, the value may be a time or use limited value.

In the first or second further examples, the security module may be further arranged to generate a first time/use-limited value for verification by the content service and to verify a second time/use-limited value received via the bus from the content service and wherein content data received with the second time/use-limited value is not rendered on the electronic paper display unless the second time/use-limited value passes the verification.

In the first or second further examples, security module may be further arranged to verify a value received via the input with content data against the value provided to the proximate computing device and wherein the content data is not rendered on the electronic paper display unless the verification is successful.

In the first or second further examples, the security module may be arranged to generate the value and communicate the value generated to both the proximate device and the content service.

In the first or second further examples, the display device may further comprise a proximity based wireless device arranged to provide the value stored and/or generated by the security module to a proximate computing device. The proximity based wireless device may be further arranged to provide a public key for the display device to the proximate computing device with a value generated by the security module and the security module is further arranged to store a private key for the display device, to decrypt, using the private key, an encrypted value and/or encrypted content data received via the bus.

In the first or second further examples, the security module may be further arranged to decrypt an encrypted value received via the input with content data to the value provided to the proximate computing device and to verify the decrypted value against the value provided to the proximate computing device and wherein the content data is not rendered on the electronic paper display unless the verification is successful.

In the first or second further examples, the input may comprise a plurality of conductive contacts connected to a contact based conductive digital data and power bus and wherein the electronic paper display can only be updated when receiving power via the bus from a printer device.

A third further example provides a computer implemented method comprising: periodically updating a value stored by a security module in a display device, the display device comprising an electronic paper display and an input for receiving content for display on the electronic paper display; and in the security module or a content service remote from the display device, verifying the value or a proposed update to the value before updating the content displayed on the electronic paper display.

In the third further example, the method may further comprise: receiving content and a value at the display device from a content service via the input; and displaying the content on the electronic paper display; and wherein periodically updating a value stored by a security module in a display device comprises: updating the value stored by the security module to the value received from the content service.

In the third further example, the method may further comprise: communicating the updated stored value to the content service via a proximate device to receive content provided by the proximate device.

In the third further example, the method may further comprise: providing the value stored by the security module to a proximate computing device using a proximity based wireless device; and verifying a value received via the input with content data against the value provided to the proximate computing device and wherein the content data is not rendered on the electronic paper display unless the verification is successful.

In the third further example, the method may further comprise: generating a first time/use-limited value in the security module for verification by the content service; and verifying a second time/use-limited value received via the input from the content service and wherein content data received with the second time/use-limited value is not rendered on the electronic paper display unless the second time/use-limited value passes the verification.

In the third further example, the input may comprise a plurality of conductive contacts connected to a contact based conductive digital data and power bus and wherein the electronic paper display can only be updated when receiving power via the bus.

A fourth further aspect provides a computing device comprising: a processor; a communication interface; and a memory arranged to store device-executable instructions that, when executed by the processor, direct the computing device: to verify a value received from either a display device comprising an electronic paper display or a second computing device; and in response to successful verification, to transmit updated content to the display device using the communication interface.

A fifth further example provides a system comprising: the display device according to any of the first and second further examples described above; and a computing device comprising: a processor; a communication interface; and a memory arranged to store device-executable instructions that, when executed by the processor, direct the computing device: to verify a value received from either a display device comprising an electronic paper display or a second computing device; and in response to successful verification, to transmit updated content to the display device using the communication interface.

In the fourth or fifth further example, the device-executable instructions, when executed by the processor, may further direct the computing device to generate a second value and to transmit the second value to the display device with the updated content.

In the fourth or fifth further example, the value may be received from the computing device with the new content for display on the electronic paper display and is verified against a value previously sent to or received from the display device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A display device comprising:
an electronic paper display arranged to display content;
a security module arranged to store and/or generate a value that is periodically updated and to communicate the value to a proximate device;
an input for receiving content for display on the electronic paper display; and
a processing element configured to drive the electronic paper display, wherein a proposed update to the displayed content is accompanied by a further value and the further value is verified by the security module or by a remote content service before updating the content displayed on the electronic paper display.

2. The display device according to claim 1, wherein the input is arranged to receive content and a value from a content service and wherein the security module is arranged to update the stored value to match the value received and to subsequently communicate a value derived from the stored value to the content service via a proximate device to receive further content.

3. The display device according to claim 2, wherein the security module is arranged to verify the value received prior to updating the stored value to match the value received.

4. The display device according to claim 1, wherein the value is a time or use limited value.

5. The display device according to claim 4, wherein the security module is further arranged to generate a first time/use-limited value for verification by the content service and to verify a second time/use-limited value received via the bus from the content service and wherein content data received with the second time/use-limited value is not rendered on the electronic paper display unless the second time/use-limited value passes the verification.

6. The display device according to claim 1, wherein the security module is further arranged to verify a value received via the input with content data against the value provided to the proximate computing device and wherein the content data is not rendered on the electronic paper display unless the verification is successful.

7. The display device according to claim 1, wherein the security module is arranged to generate the value and communicate the value generated to both the proximate device and the content service.

8. The display device according to claim 1, wherein the display device further comprises a proximity based wireless device arranged to provide the value stored and/or generated by the security module to a proximate computing device.

9. The display device according claim 8, wherein the proximity based wireless device is further arranged to provide a public key for the display device to the proximate computing device with a value generated by the security module and the security module is further arranged to store a private key for the display device, to decrypt, using the private key, an encrypted value and/or encrypted content data received via the bus.

10. The display device according to claim 9, wherein the security module is further arranged to decrypt an encrypted value received via the input with content data to the value provided to the proximate computing device and to verify the decrypted value against the value provided to the proximate computing device and wherein the content data is not rendered on the electronic paper display unless the verification is successful.

11. The display device according to claim 1, wherein the input comprises a plurality of conductive contacts connected to a contact based conductive digital data and power bus and wherein the electronic paper display can only be updated when receiving power via the bus from a printer device.

12. A computer implemented method comprising:
periodically updating a value stored by a security module in a display device, the display device comprising an electronic paper display and an input for receiving content for display on the electronic paper display; and
in the security module or a content service remote from the display device, verifying the value or a proposed update to the value before updating the content displayed on the electronic paper display.

13. The method according to claim 12, further comprising:
receiving content and a value at the display device from a content service via the input; and
displaying the content on the electronic paper display;
and wherein periodically updating a value stored by a security module in a display device comprises:
updating the value stored by the security module to the value received from the content service.

14. The method according to claim 13, wherein the method further comprises:
communicating the updated stored value to the content service via a proximate device to receive content provided by the proximate device.

15. The method according to claim 12, further comprising:
providing the value stored by the security module to a proximate computing device using a proximity based wireless device; and
verifying a value received via the input with content data against the value provided to the proximate computing device and wherein the content data is not rendered on the electronic paper display unless the verification is successful.

16. The method according to claim 12, further comprising:
generating a first time/use-limited value in the security module for verification by the content service; and
verifying a second time/use-limited value received via the input from the content service and wherein content data received with the second time/use-limited value is not rendered on the electronic paper display unless the second time/use-limited value passes the verification.

17. The computer implemented method according to claim 12, wherein the input comprises a plurality of conductive contacts connected to a contact based conductive digital data and power bus and wherein the electronic paper display can only be updated when receiving power via the bus.

18. A computing device comprising:
a processor;
a communication interface; and
a memory arranged to store device-executable instructions that, when executed by the processor, direct the computing device:
to verify a value received from either a display device comprising an electronic paper display or a second computing device; and
in response to successful verification, to transmit updated content to the display device using the communication interface.

19. The computing device according to claim 18, wherein the device-executable instructions, when executed by the processor, further direct the computing device to generate a second value and to transmit the second value to the display device with the updated content.

20. The computing device according to claim 18, wherein the value is received from the computing device with the new content for display on the electronic paper display and is verified against a value previously sent to or received from the display device.
